(19) United States
(12) Patent Application Publication
(10) Pub. No.: US 2010/0010855 A1
(43) Pub. Date: Jan. 14, 2010

(54) Scheduling a Meeting of Users of Networked Computers

(76) Inventors: Cheng-Chieh Cheng, Rochester, MN (US); Teresa C. Kan, Rochester, MN (US); Li-Fang Lee, Rochester, MN (US); Jian Tang, Rochester, MN (US)

Correspondence Address: IBM CORPORATION, 3605 HIGHWAY 52 NORTH, DEPT 917, ROCHESTER, MN, 55901-7829, US

(21) Appl. No.: 12/172,611

(22) Filed: Jul. 14, 2008

(51) Int. Cl. G06Q 10/00

(52) U.S. Cl. 705/8

(57) ABSTRACT

During scheduling a meeting between users of networked computers, participants are assigned to groups of different priority based on importance of participant's presence at the meeting. Proposed schedule of the meeting is confirmed with the participants in an order of priority of their groups. The meeting is scheduled on a time interval during which availability of the participants is compliant with pre-selected group attendance requirements.

### BACKGROUND OF THE INVENTION

1. Technical Field

The present invention generally relates to the field of business administration and, in particular, to techniques for scheduling a meeting between users of networked computers.

2. Description of the Related Art

In a business environment, scheduling of a meeting between multiple participants has proved to be a challenging task, which requires matching the meeting's objectives (e.g., timeframe, presence of particular participants, quorum, etc.) with daily schedules and commitments of individual participants. Complexity of this task increases with a number of the participants and/or business units/enterprises the participants are associated with.

Existing electronic calendar tools allow to notify participants on a timing of the meeting and inquire on their availability; however, they lack the flexibility needed for matching the objectives of the meeting with availability of the participants.

Especially in the case where the meeting participants have different degrees of impact on the productivity of the meeting, ensuring that the participants with higher priorities have better chance to attend the meeting is very important.

### SUMMARY OF ILLUSTRATIVE EMBODIMENTS

A method, system, and computer program product for scheduling a meeting between users of networked computers are disclosed.

In one embodiment, during scheduling a meeting between users of networked computers, participants are assigned to groups of different priorities based on importance of participant's presence at the meeting, and then meeting's attendance requirements are selectively determined for each of the groups. A timeframe for the meeting is defined using information retrieved from calendar tools of the participant's computers and may include a choice of several time intervals for conducting the meeting. A proposed schedule of the meeting is confirmed with the participants in an order of priority of their groups. In one embodiment, the proposed schedule is confirmed with members of a group having a higher priority before confirming with members of a group having a lower priority. The meeting is scheduled on a time interval during which availability of the members of groups satisfies the attendance requirements.

When a meeting scheduling fails to meet the attendance requirement, the scheduler will automate the process of resolving scheduling conflicts among members. In one embodiment, the scheduler may suggest particular members to adjust/modify their personal availability schedules and then it will try to schedule the meeting again.

All objects, features and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of a computer system configured for implementing one or more embodiments of the invention;

FIG. 2 is a high level flowchart of a process by which the features of the invention are implemented, according to one embodiment of the invention; and

FIG. 3 is a high level flowchart illustrating a portion of the process of FIG. 2, according to one embodiment of the invention.

The images in the drawings are simplified for illustrative purposes and are not depicted to scale. To facilitate understanding, identical reference numerals are used, where possible, to designate substantially identical elements that are common to the figures, except that suffixes may be added, when appropriate, to differentiate such elements.

It has been contemplated that features or steps of one embodiment may be incorporated in other embodiments of the invention without further recitation.

### DETAILED DESCRIPTION OF AN ILLUSTRATIVE EMBODIMENT

The present invention provides a method, system, and computer program product for scheduling a meeting between users of networked computers, such as personal computers, mobile communicating devices, or workstations. The invention may be advantageously utilized, for example, in business environments of individual or cooperating enterprises.

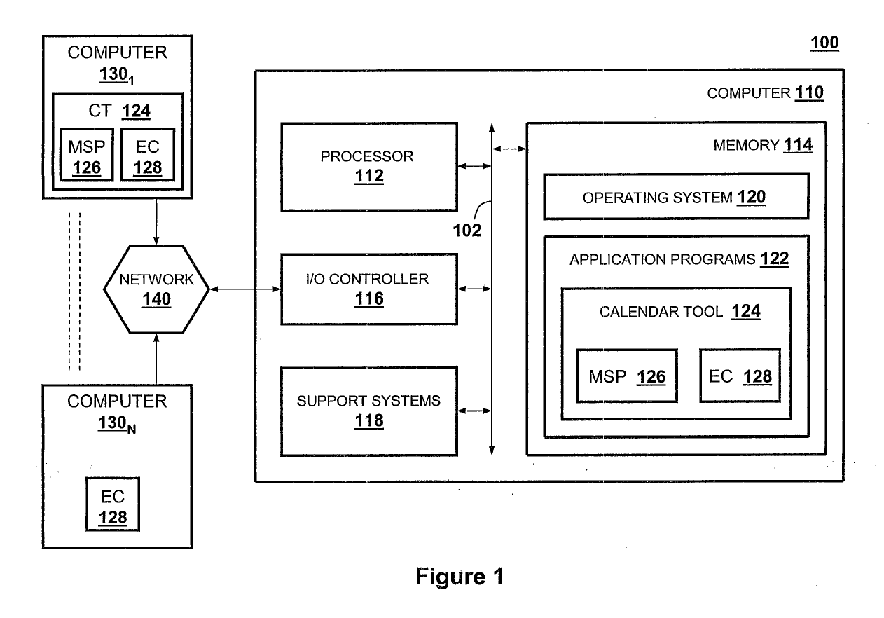

With reference now to the figures, and in particular with reference to FIG. 1, there is illustrated a high level block diagram of an illustrative embodiment of computer system 100 in accordance with the present invention. In particular, computer system 100 includes computer 110, a plurality of computers 130 (N computers 130 are shown), and network 140 (e.g., intranet, LAN, WAN, or the Internet), which communicatively interconnects computers 110 and 130.

Computer 110 and 130 may be general purpose or specialized workstations, stationary/mobile computers, or mobile communicating devices (e.g., personal digital assistants (PDAs, mobile phones, and the like). Via network 140, users of computers 110, 130 may communicate to one another (for example, by using e-mail). In one embodiment, a user of computer 110 is a scheduler of a meeting between users of computers 130. Additionally, the user of computer 110 may also be a participant of the meeting.

Computer 110 generally comprises processor 112, memory 114, input/output (I/O) controller 116 providing connectivity to network 140, support systems 118, and system interface 102. Components of computer 100 may be implemented as hardware devices, software modules, firmware, or any combination thereof. Memory 114 may include cache memory, random access memory (RAM), read only memory (ROM), and/or firmware memory, among other storage elements.

In the depicted embodiment, memory 114 contains operating system (OS) 120 and application programs 122. In computer 110, OS 120 (e.g., Microsoft Windows®, GNU®/Linux®, or Advanced Interactive eXecutive® (AIX) operating system, etc.) supports execution and user interface features of application programs 122. In alternate embodiments, at least portions of OS 120 and application programs 122 may reside in a remote memory device (not shown) communicatively coupled to computer 110.

In computer 110, application programs 122 include, among other software and/or firmware components, calendar tool (CT) 124 having meeting scheduling program (MSP) 126 and electronic calendar (EC) 128. In operation, MSP 126 facilitates scheduling of a meeting between users of computers 130. MSP 126 is illustrated and described herein as a stand-alone (i.e., separate) component of calendar tool 124. In alternate embodiments, at least portions of MSP 126 may be combined with software/firmware modules of calendar tool 124 or other application programs 122.

In one embodiment, computers 130 include, among other software and/or firmware components thereof, comprising electronic calendars 128 and, optionally, calendar tools 124 and/or MSPs 126. Via network 140, contents of electronic calendars 128 of computers 130 are accessible by calendar tool 124 and/or MSP 126 of computer 110. User of computer 110 and users of computers 130 having MSPs 126 may perform functions of a scheduler of a meeting.

Among the software instructions provided by MSP 126 and which are specific to the invention, are: (a) code for assigning meeting's participants to groups having different priorities based on importance of participant's presence at the meeting; (b) code for selectively determining meeting's attendance requirements for each one of said groups; (c) code for defining a timeframe for the meeting, the timeframe having one or more time intervals for conducting the meeting; (d) code for confirming the timeframe and/or the time intervals with the participants in an order of priority of their groups; and; and (e) code for scheduling the meeting on a time interval during which availability of the members of the groups satisfies the attendance requirements thereof.

Those of ordinary skill in the art will appreciate that hardware and software configurations depicted in FIG. 1 may vary. For example, other hardware and/or software components may be used in computers 110 and 130 in addition to or in place of the depicted components.

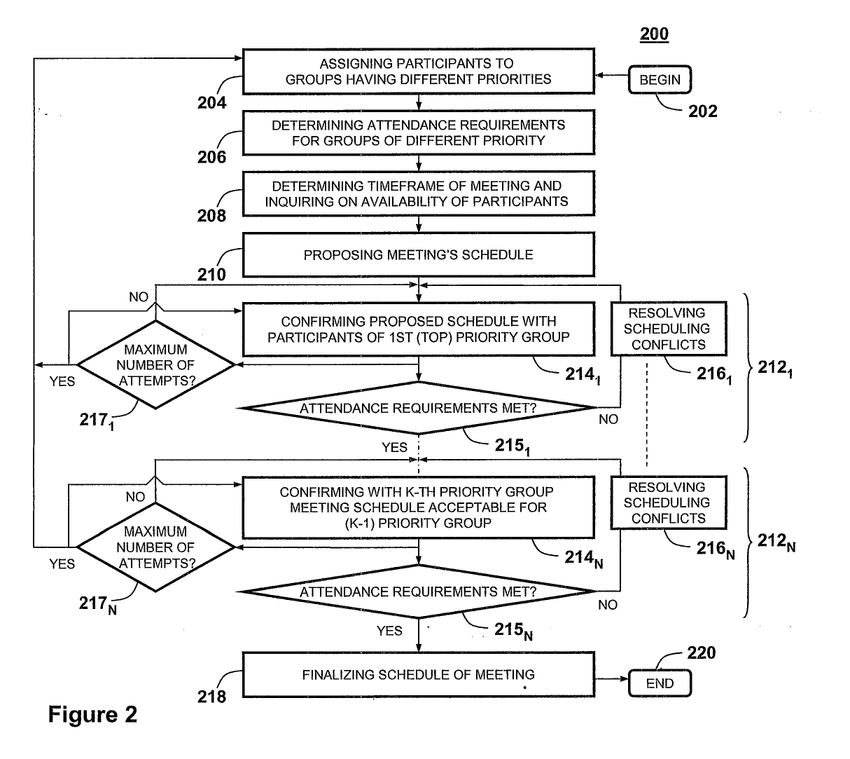

With reference now to FIG. 2, there is illustrated a high level logical flowchart of process 200 for scheduling by a user of computer 110 of a meeting between users of computers 130 in accordance with one embodiment of the present invention. To best understand the invention, the reader should refer to both FIGS. 1 and 2.

As shown, process 200 begins at block 202 and thereafter proceeds to block 204. At block 204, a scheduler of a meeting (i.e., user of computer 110) selectively assigns participants of the meeting (i.e., users of computers 130 and, optionally, him/herself) to groups having different priorities, which are determined based on importance of participant's presence at the meeting. Within a group, members thereof are considered as equally significant participants of the meeting. The scheduler may form the groups based on his/her personal judgment, input from key employees (for example, project managers, subject matter experts, etc.), other participants of the meeting, or use pre-defined lists of the groups and/or their members.

At block 206, the scheduler determines meeting's attendance requirements AR for each of the groups of the participants. In one embodiment, depending, for example, on the meeting's agenda or a number of members in a group, an attendance requirement AR for a particular group may vary from 0% (presence of the members of the group is optional) to 100%, when presence of all members of the group is required at the meeting. For example, groups having AR=0% may not participate in the meeting, while attendance of the groups having AR=100% is necessary.

At block 208, the scheduler selects a timeframe ΔT for the meeting (for example, a particular period of time, such as a day, a week, a month, etc.) and, via network 140, collects data on availability of the participants during the timeframe ΔT. In one embodiment, MSP 126 retrieves from computers 130 information on availability of the participants during the selected timeframe. In particular, MSP 126 may retrieve entries from electronic calendars 128 of the participants.

At block 210, MSP 126 analyzes information on availability of the meeting's participants and proposes a meeting schedule having, within the timeframe ΔT, one or more suggested time intervals Δt for conducting the meeting. Generally, MSP 126 proposes the meeting schedule having several time intervals Δt, each such time interval equal to a duration of the meeting. The time intervals Δt are determined as best matches for availability data of the individual participants of the meeting. In one embodiment, to determine the time intervals Δt, MSP 126 processes the participant's availability data using weight coefficients, which are chosen based on the priority of the groups these participants have been assigned to at preceding block 204.

Then, process 200 sequentially performs processing steps of sequences 212₁-212_{K}, where K is equal to a number of the groups of the participants of the meeting. Sequences 212 confirm the timeframe ΔT and/or the time intervals Δt with the participants in an order of priority of their groups. In one embodiment, members of a group having a higher priority confirm their availability for the meeting before members of a group having a lower priority, who are offered to choose from the time intervals acceptable to the group having a higher priority. When an attendance requirement AR for a particular group is not satisfied, MSP 126 may iteratively adjust the assignment of the participants to the groups (block 204), attendance requirements AR (block 206), timeframe ΔT (block 206), or time intervals Δt to schedule the meeting.

Referring to sequence 212₁, at block 214₁ the proposed schedule of the meeting is confirmed with members of a group G₁ having, among other groups, the highest priority. Specifically, MSP 126 asks the members of the group G₁ (for example, via e-mail) to confirm their availability for the meeting during the timeframe ΔT and the time intervals Δt and then analyzes their responses to the request.

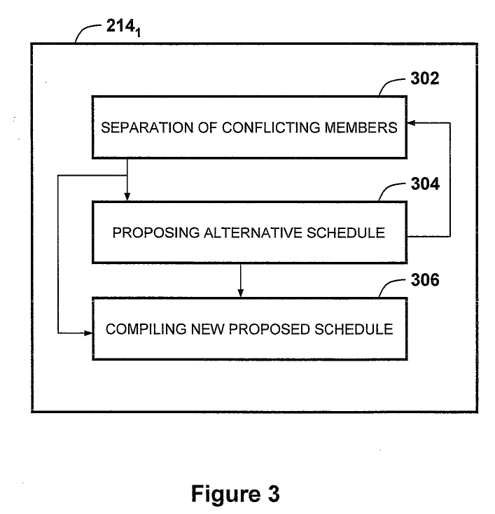

Referring to FIG. 3, during block 214₁, particular repetitive decision steps may include at least some procedures such as separation of conflicting (i.e., no-available) members (sub-block 302), proposing an alternative schedule (sub-block 304), and compiling a new proposed schedule (sub-block 306).

At block 215₁, MSP 126 queries whether an attendance requirement AR₁ for the group G₁ is satisfied during at least one time interval Δt. If the query is answered positively, process 200 proceeds to sequence 212₂.

If, however, the query is answered negatively, sequence 212₁ proceeds to block 216₁, in which MSP 126 attempts to resolve scheduling conflicts between members of the group G₁. For example, MSP 126 may suggest particular members to adjust/modify their personal schedules and thereafter downloads from computers 130 thereof updated information on member's availability. Then, sequence 212₁ proceeds back to block 214₁ to confirm with the members of group G₁ the update on their availability during the timeframe ΔT and the time intervals Δt, analyzes their responses, and then may proceed to blocks 215₁ and 216₁, as discussed above.

Attempts to satisfy the attendance requirement AR₁ continue until a number M of the attempts reaches a pre-determined threshold (i.e., maximum number) Q₁. When the threshold Q₁ is reached, at block 217₁ MSP 126 terminates further attempts to satisfy the attendance requirement AR₁, and sequence 212₁ proceeds back to block 204. Thereafter, the assignment of the participants to the groups (block 204), attendance requirements AR (block 206), timeframe ΔT (block 206), or time intervals may be adjusted or modified.

At sequence 212₂, MSP 126 asks members of the group G₂ having, among other groups, the second highest priority to confirm their availability during the time interval(s) that have satisfied the attendance requirement AR₁ of group G₁. In one embodiment, MSP 126 attempts to satisfy attendance requirement AR₂ of group G₂ as discussed above in reference to attendance requirement AR₁ of group G₁.

Sequences 212 continue as discussed above until availability of the members is confirmed and attendance requirements of their groups are satisfied for of all K groups of the participants. Then, at block 218, MSP 126 schedules the meeting on a time interval Δt₀ during which availability of members of the groups satisfies their respective attendance requirements. Upon completion of block 218, process 200 ends at block 220. Of course, the process can be repeated, as necessary, in response to a rescheduling request by a required participant.

While the invention has been particularly shown as described with reference to a preferred embodiment, it will be understood by those skilled in the art that various changes in form and detail may be made therein without departing from the spirit and scope of the invention. For example, it will be appreciated that the concepts disclosed herein may be extended or modified to apply to other types of configuration entities than those disclosed herein. In addition, those skilled in the understand upon reference to the foregoing that any of a wide variety of rules may be applied to determine which configuration entities are presented, meaning that the particular syntax and presentation rules described herein are merely exemplary and not exhaustive.

Furthermore, although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette, flash memory, or hard disk drive). It should be understood, therefore, that such signal-bearing media, when carrying or encoding computer readable instructions that direct the functions of the present invention, represent alternative embodiments of the present invention.

What is claimed is:

1. A method for scheduling a meeting between users of networked computers, comprising:
assigning meeting participants to groups having different priorities based on importance of participant's presence at the meeting;
selectively determining meeting's attendance requirements for each one of said groups;
defining a timeframe for the meeting, the timeframe having one or more time intervals for conducting the meeting;
confirming at least said timeframe with the participants in an order of priority of their groups; and
scheduling the meeting on a time interval during which availability of the members of the groups satisfies the attendance requirements thereof.

2. The method of claim 1, wherein said confirming further comprises:
confirming said timeframe with members of a group having a higher priority before confirming with members of a group having a lower priority.

3. The method of claim 1, and further comprising:
adjusting at least one of a set including assignment of the participants to the groups, the attendance requirements, the timeframe, and the one or more time intervals.

4. The method of claim 1, and further comprising:
providing a group having a lower priority with a choice of the time intervals that match an attendance requirement of a group having a higher priority.

5. The method of claim 1, and further comprising:
retrieving from electronic calendars of the networked computers information used to determine said timeframe and said one or more time intervals.

6. The method of claim 1, and further comprising:
requesting at least a portion of the participants to modify their availability during said timeframe in order to satisfy the attendance requirements.

7. A data processing system, comprising:
a processor;
an input/output controller configured for communicatively coupling said computer to a plurality of networked computers; and
a memory including a code of a program for scheduling a meeting between users of the networked computers, said program performing operations including:
assigning meeting participants to groups having different priorities based on importance of participant's presence at the meeting;
selectively determining meeting's attendance requirements for each one of said groups;
defining a timeframe for the meeting, the timeframe having one or more time intervals for conducting the meeting;
confirming at least said timeframe with the participants in an order of priority of their groups; and
scheduling the meeting on a time interval during which availability of the members of the groups satisfies the attendance requirements thereof.

8. The data processing system of claim 7, wherein said confirming further includes confirming said timeframe with members of a group having a higher priority before confirming with members of a group having a lower priority.

9. The data processing system of claim 7, wherein said operations further include adjusting at least one of a set including an assignment of the participants to the groups, the attendance requirements, the timeframe, and the one or more time intervals.

10. The data processing system of claim 7, wherein said operations further include providing a group having a lower priority with a choice of the time intervals that match an attendance requirement of a group having a higher priority.

11. The data processing system of claim 7, wherein said operations further include retrieving from electronic calendars of the networked computers information used to determine said timeframe and said one or more time intervals.

12. The data processing system of claim 7, wherein said operations further include requesting at least a portion of the participants to modify their availability during said timeframe in order to satisfy the attendance requirements.

13. A computer program product for scheduling a meeting between users of networked computers, said computer program product comprising:
a data storage medium; and
computer program code within the data storage medium, said computer program code including instructions for:
assigning meeting participants to groups having different priorities based on importance of participant's presence at the meeting;
selectively determining meeting's attendance requirements for each one of said groups;
defining a timeframe for the meeting, the timeframe having one or more time intervals for conducting the meeting;
confirming at least said timeframe with the participants in an order of priority of their groups; and
scheduling the meeting on a time interval during which availability of the members of the groups satisfies the attendance requirements thereof.

14. The computer program product of claim 13, wherein said instructions for confirming include instructions for confirming said timeframe with members of a group having a higher priority before confirming with members of a group having a lower priority.

15. The computer program product of claim 13, wherein said computer program code further includes instructions for adjusting at least one of a set including an assignment of the participants to the groups, the attendance requirements, the timeframe, and the one or more time intervals.

16. The computer program product of claim 13, wherein said computer program code further includes instructions for providing a group having a lower priority with a choice of the time intervals that match an attendance requirement of a group having a higher priority.

17. The computer program product of claim 13, wherein said computer program code further includes instructions for retrieving from electronic calendars of the networked computers information used to determine said timeframe and said time intervals.

18. The computer program product of claim 13, wherein said computer program code further includes instructions for requesting at least a portion of the participants to modify their availability during said timeframe in order to satisfy the attendance requirements.
